(19) United States
(12) Patent Application Publication
(10) Pub. No.: US 2006/0023187 A1
(43) Pub. Date: Feb. 2, 2006

(54) Environmental system including an electro-osmotic element for an immersion lithography apparatus

(75) Inventor: John K. Eaton, Stanford, CA (US)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 11/239,075

(22) Filed: Sep. 30, 2005

Related U.S. Application Data
(63) Continuation of application No. PCT/IB04/01376, filed on Apr. 4, 2004.
(60) Provisional application No. 60/462,115, filed on Apr. 10, 2003.

(51) Int. Cl. G03B 27/42

(52) U.S. Cl. 355/53; 355/30

(57) ABSTRACT

An environmental system that controls an environment in a gap between an optical assembly and a device includes a fluid barrier, an immersion fluid system, an electro-osmotic element, and a control system. The fluid barrier is positioned near the device and maintains the electro-osmotic element near the gap. The immersion fluid system delivers an immersion fluid that fills the gap. The control system applies an electrical voltage to the electro-osmotic element that causes the electro-osmotic element to transport at least a portion of the immersion fluid that is near the fluid barrier and the device away from the device. The electro-osmotic element can be made of a porous material.

### RELATED APPLICATIONS

This is a Continuation of International Application No. PCT/IB2004/001376 filed Apr. 4, 2004, which claims the benefit of U.S. Provisional Application No. 60/462,115 filed Apr. 10, 2003. The disclosures of these applications are incorporated herein by reference in their entireties.

### BACKGROUND

Exposure apparatus are commonly used to transfer images from a reticle onto a semiconductor wafer during semiconductor processing. A typical exposure apparatus includes an illumination source, a reticle stage assembly that positions a reticle, an optical assembly, a wafer stage assembly that positions a semiconductor wafer, and a measurement system that precisely monitors the position of the reticle and the wafer.

Immersion lithography systems utilize a layer of immersion fluid that fills a gap between the optical assembly and the wafer. For example, the fluid can completely fill the gap. The wafer is moved rapidly in a typical lithography system and it would be expected to carry the immersion fluid away from the gap. This immersion fluid that escapes from the gap can interfere with the operation of other components of the lithography system. For example, the immersion fluid can interfere with the measurement system that monitors the position of the wafer.

### SUMMARY

The invention is directed to an environmental system for controlling an environment in a gap between an optical assembly and a device that is retained by a device stage. The environmental system includes an immersion fluid source, an electro-osmotic element that is positioned near the device, and a transport control system that applies an electrical voltage to the electro-osmotic element. The electro-osmotic element is also referred to as an electrokinetic element. The immersion fluid source delivers an immersion fluid that enters the gap. The electro-osmotic element functions as an electrokinetic sponge or electro-osmotic pump that captures the immersion fluid that is exiting the gap. With this design, in certain embodiments, the invention avoids the use of direct vacuum suction on the device that could potentially distort the device and/or the optical assembly.

In one embodiment, the environmental system includes a fluid barrier that is positioned near the device and that encircles the gap. Furthermore, the fluid barrier can maintain the electro-osmotic element near the device.

In one embodiment, the electro-osmotic element can be made of a material that conveys the immersion fluid by capillary action. For example, the electro-osmotic element can be a substrate, such as a sponge, that includes a plurality of pores. In one embodiment, the substrate is a glass frit.

The invention also is directed to an exposure apparatus, a wafer, a device, a method for controlling an environment in a gap, a method for making an exposure apparatus, a method for making a device, and a method for manufacturing a wafer.

### BRIEF DESCRIPTION OF THE DRAWINGS

The invention will be described in conjunction with the following drawings of exemplary embodiments in which like reference numerals designate like elements, and in which:

FIG. 1 is a side illustration of an exposure apparatus having features of the invention;

FIG. 2A is a perspective view of a portion of the exposure apparatus of FIG. 1;

FIG. 2B is a cut-away view taken on line 2B-2B of FIG. 2A;

FIG. 2C is an enlarged detailed view taken on line 2C-2C in FIG. 2B;

FIG. 2D is a perspective view of a transport housing from FIG. 2B;

FIG. 2E is a perspective view of a portion of a electro-osmotic element having features of the invention;

FIG. 3A is a bottom view of another embodiment of the electro-osmotic element;

FIG. 3B is a bottom view of another embodiment of the electro-osmotic element:

FIG. 4 is a perspective view of another embodiment of the transport housing and an electro-osmotic element having features of the invention;

FIG. 5A is a flow chart that outlines a process for manufacturing a device in accordance with the invention; and

FIG. 5B is a flow chart that outlines device processing in more detail.

### DETAILED DESCRIPTION OF EMBODIMENTS

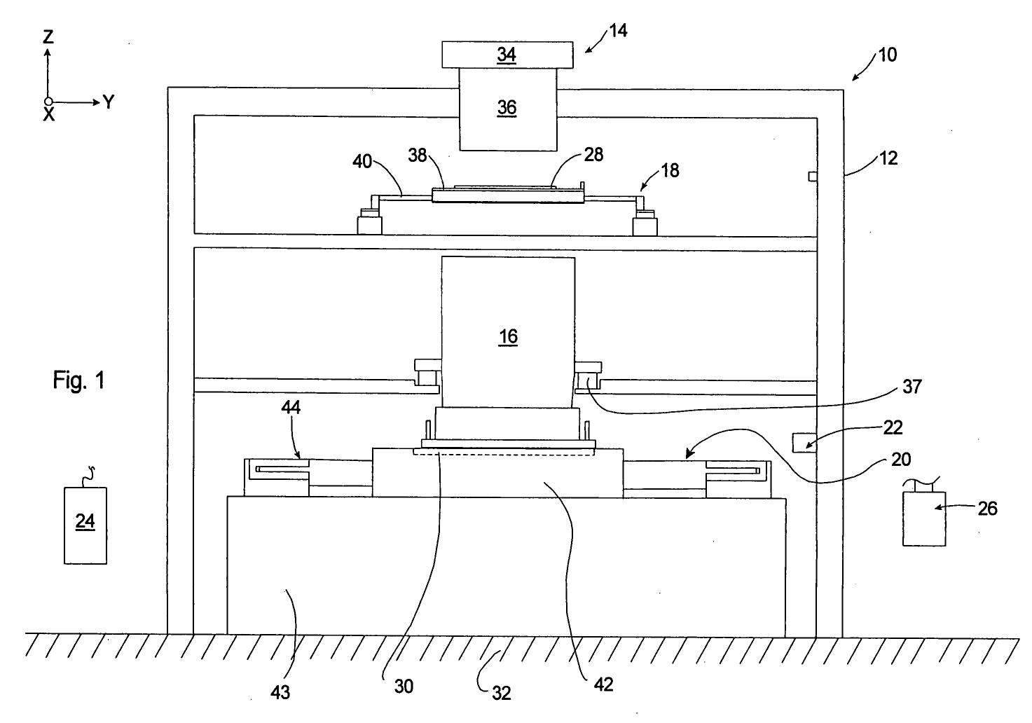

FIG. 1 is a schematic illustration of a precision assembly, namely an exposure apparatus 10 having features of the invention. The exposure apparatus 10 includes an apparatus frame 12, an illumination system 14 (irradiation apparatus), an optical assembly 16, a reticle stage assembly 18, a device stage assembly 20, a measurement system 22, a control system 24, and a fluid environmental system 26.

A number of Figures include an orientation system that illustrates an X axis, a Y axis that is orthogonal to the X axis, and a Z axis that is orthogonal to the X and Y axes. It should be noted that these axes also can be referred to as the first, second and third axes.

The exposure apparatus 10 is particularly useful as a lithographic device that transfers a pattern (not shown) of an integrated circuit from a reticle 28 onto a semiconductor wafer 30 (illustrated in phantom). The wafer 30 also is referred to generally as a device, or work piece. The exposure apparatus 10 mounts to a mounting base 32, e.g., the ground, a base, or floor or some other supporting structure.

There are a number of different types of lithographic devices. For example, the exposure apparatus 10 can be used as a scanning type photolithography system that exposes the pattern from the reticle 28 onto the wafer 30 with the reticle 28 and the wafer 30 moving synchronously. In a scanning type lithographic apparatus, the reticle 28 is moved perpendicularly to an optical axis of the optical assembly 16 by the reticle stage assembly 18 and the wafer 30 is moved perpendicularly to the optical axis of the optical assembly 16 by the wafer stage assembly 20. Irradiation of the reticle 28 and exposure of the wafer 30 occur while the reticle 28 and the wafer 30 are moving synchronously.

Alternatively, the exposure apparatus 10 can be a step-and-repeat type photolithography system that exposes the reticle 28 while the reticle 28 and the wafer 30 are stationary. In the step and repeat process, the wafer 30 is in a constant position relative to the reticle 28 and the optical assembly 16 during the exposure of an individual field. Subsequently, between consecutive exposure steps, the wafer 30 is consecutively moved with the wafer stage assembly 20 perpendicularly to the optical axis of the optical assembly 16 so that the next field of the wafer 30 is brought into position relative to the optical assembly 16 and the reticle 28 for exposure. Following this process, the images on the reticle 28 are sequentially exposed onto the fields of the wafer 30, and then the next field of the wafer 30 is brought into position relative to the optical assembly 16 and the reticle 28.

However, the use of the exposure apparatus 10 provided herein is not limited to a photolithography system for semiconductor manufacturing. The exposure apparatus 10, for example, can be used as an LCD photolithography system that exposes a liquid crystal display device pattern onto a rectangular glass plate or a photolithography system for manufacturing a thin film magnetic head.

The apparatus frame 12 supports the components of the exposure apparatus 10. The apparatus frame 12 illustrated in FIG. 1 supports the reticle stage assembly 18, the wafer stage assembly 20, the optical assembly 16 and the illumination system 14 above the mounting base 32.

The illumination system 14 includes an illumination source 34 and an illumination optical assembly 36. The illumination source 34 emits a beam (irradiation) of light energy. The illumination optical assembly 36 guides the beam of light energy from the illumination source 34 to the optical assembly 16. The beam illuminates selectively different portions of the reticle 28 and exposes the wafer 30. In FIG. 1, the illumination source 34 is illustrated as being supported above the reticle stage assembly 18. Typically, however, the illumination source 34 is secured to one of the sides of the apparatus frame 12 and the energy beam from the illumination source 34 is directed to above the reticle stage assembly 18 with the illumination optical assembly 36.

The optical assembly 16 projects and/or focuses the light passing through the reticle 28 onto the wafer 30. Depending upon the design of the exposure apparatus 10, the optical assembly 16 can magnify or reduce the image illuminated on the reticle 28. The optical assembly 16 need not be limited to a reduction system. It also could be a 1× or magnification system.

Also, with an exposure device that employs ultra-violet radiation (VUV) of wavelength 200 nm or lower, use of the catadioptric type optical system can be considered. Examples of the catadioptric type of optical system include Japanese Laid-Open Patent Application Publication No. 8-171054 and its counterpart U.S. Pat. No. 5,668,672, as well as Japanese Laid-Open Patent Application Publication No. 10-20195 and its counterpart U.S. Pat. No. 5,835,275. In these cases, the reflecting optical device can be a catadioptric optical system incorporating a beam splitter and concave mirror. Japanese Laid-Open Patent Application Publication No. 8-334695 and its counterpart U.S. Pat. No. 5,689,377 as well as Japanese Laid-Open Patent Application Publication No. 10-3039 and its counterpart U.S. Patent Application No. 873,605 (Application Date: Jun. 12, 1997) also use a reflecting-refracting type of optical system incorporating a concave mirror, etc., but without a beam splitter, and also can be employed with this invention. The disclosures in the above-mentioned U.S. patents, as well as the Japanese Laid-Open patent application Publications are incorporated herein by reference in their entireties.

In one embodiment, the optical assembly 16 is secured to the apparatus frame 12 with one or more optical mount isolators 37. The optical mount isolators 37 inhibit vibration of the apparatus frame 12 from causing vibration to the optical assembly 16. Each optical mount isolator 37 can include a pneumatic cylinder (not shown) that isolates vibration and an actuator (not shown) that isolates vibration and controls the position with at least two degrees of motion. Suitable optical mount isolators 37 are sold by Integrated Dynamics Engineering, located in Woburn, Mass. For ease of illustration, two spaced apart optical mount isolators 37 are shown as being used to secure the optical assembly 16 to the apparatus frame 12. However, for example, three spaced apart optical mount isolators 37 can be used to kinematically secure the optical assembly 16 to the apparatus frame 12.

The reticle stage assembly 18 holds and positions the reticle 28 relative to the optical assembly 16 and the wafer 30. In one embodiment, the reticle stage assembly 18 includes a reticle stage 38 that retains the reticle 28 and a reticle stage mover assembly 40 that moves and positions the reticle stage 38 and reticle 28.

Somewhat similarly, the device stage assembly 20 holds and positions the wafer 30 with respect to the projected image of the illuminated portions of the reticle 28. In one embodiment, the device stage assembly 20 includes a device stage 42 that retains the wafer 30, a device stage base 43 that supports and guides the device stage 42, and a device stage mover assembly 44 that moves and positions the device stage 42 and the wafer 30 relative to the optical assembly 16 and the device stage base 43. The device stage 42 is described in more detail below.

Each stage mover assembly 40, 44 can move the respective stage 38, 42 with three degrees of freedom, less than three degrees of freedom, or more than three degrees of freedom. For example, in alternative embodiments, each stage mover assembly 40, 44 can move the respective stage 38, 42 with one, two, three, four, five or six degrees of freedom. The reticle stage mover assembly 40 and the device stage mover assembly 44 can each include one or more movers, such as rotary motors, voice coil motors, linear motors utilizing a Lorentz force to generate drive force, electromagnetic movers, planar motors, or other force movers.

In photolithography systems, when linear motors (see U.S. Pat. No. 5,623,853 or 5,528,118) are used in the wafer stage assembly or the reticle stage assembly, the linear motors can be either an air levitation type employing air bearings or a magnetic levitation type using Lorentz force or reactance force. Additionally, the stage could move along a guide, or it could be a guideless type stage that uses no guide. The disclosures of U.S. Pat. Nos. 5,623,853 and 5,528,118 are incorporated herein by reference in their entireties.

Alternatively, one of the stages could be driven by a planar motor that drives the stage by an electromagnetic force generated by a magnet unit having two-dimensionally arranged magnets and an armature coil unit having two-dimensionally arranged coils in facing positions. With this type of driving system, either the magnet unit or the armature coil unit is connected to the stage base and the other unit is mounted on the moving plane side of the stage.

Movement of the stages as described above generates reaction forces that can affect performance of the photolithography system. Reaction forces generated by the wafer (substrate) stage motion can be mechanically transferred to the floor (ground) by use of a frame member as described in U.S. Pat. No. 5,528,100 and Japanese Laid-Open Patent Application Publication No. 8-136475. Additionally, reaction forces generated by the reticle (mask) stage motion can be mechanically transferred to the floor (ground) by use of a frame member as described in U.S. Pat. No. 5,874,820 and Japanese Laid-Open Patent Application Publication No. 8-330224. The disclosures of U.S. Pat. Nos. 5,528,100 and 5,874,820 and Japanese Laid-Open Patent Application Publication Nos. 8-330224 and 8-136475 are incorporated herein by reference in their entireties.

The measurement system 22 monitors movement of the reticle 28 and the wafer 30 relative to the optical assembly 16 or some other reference. With this information, the control system 24 can control the reticle stage assembly 18 to precisely position the reticle 28 and the device stage assembly 20 to precisely position the wafer 30. The design of the measurement system 22 can vary. For example, the measurement system 22 can utilize multiple laser interferometers, encoders, mirrors, and/or other measuring devices.

The control system 24 receives information from the measurement system 22 and controls the stage assemblies 18, 20 to precisely position the reticle 28 and the wafer 30. Additionally, the control system 24 can control the operation of the components of the environmental system 26. The control system 24 can include one or more processors and circuits.

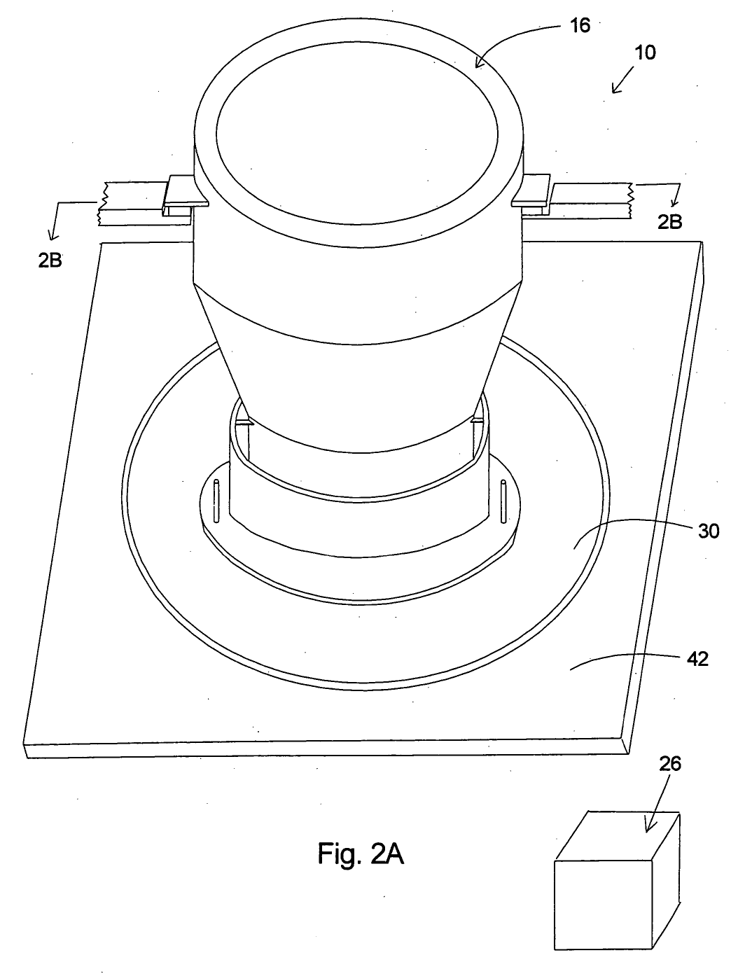

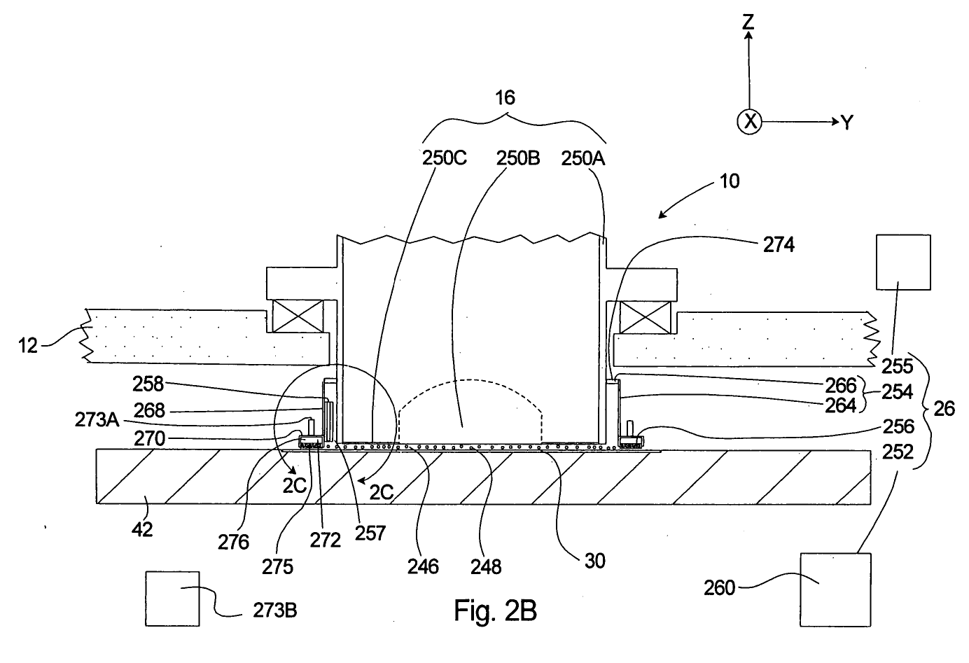

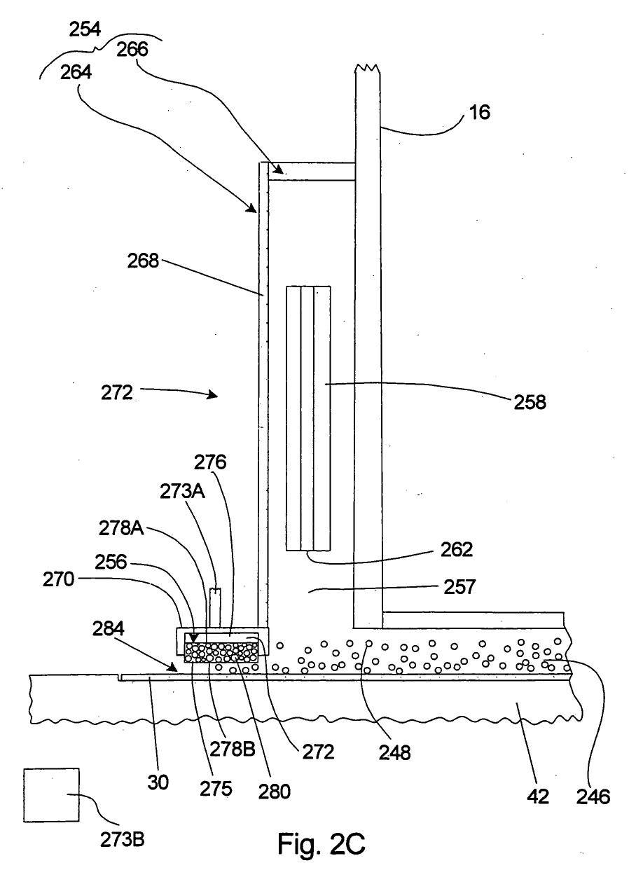

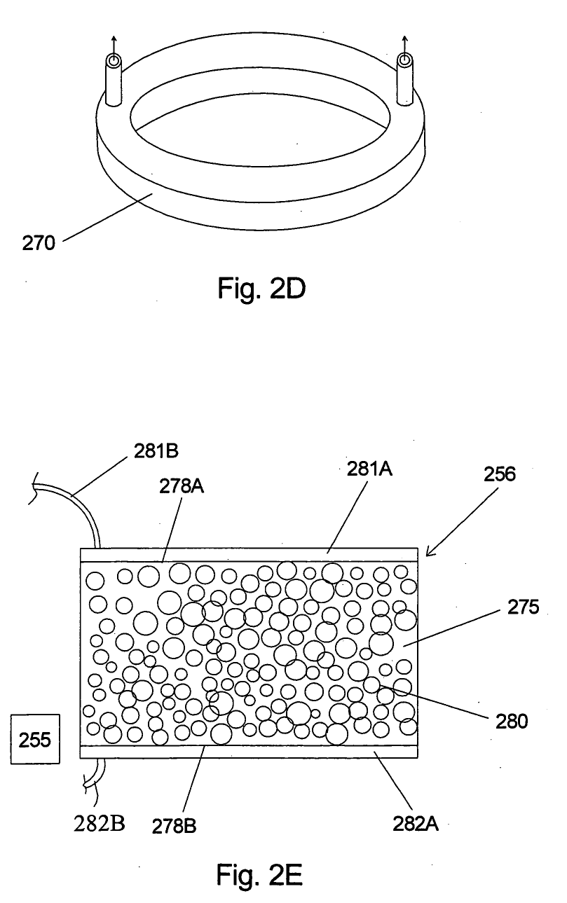

The environmental system 26 controls the environment in a gap 246 (illustrated in FIG. 2B) between the optical assembly 16 and the wafer 30. The gap 246 includes an imaging field. The imaging field includes the area adjacent to the region of the wafer 30 that is being exposed and the area in which the beam of light energy travels between the optical assembly 16 and the wafer 30. With this design, the environmental system 26 can control the environment in the imaging field.

The desired environment created and/or controlled in the gap 246 by the environmental system 26 can vary according to the wafer 30 and the design of the rest of the components of the exposure apparatus 10, including the illumination system 14. For example, the desired controlled environment can be a fluid such as water. More specifically, the fluid can be de-gassed, de-ionized water. Alternatively, the desired controlled environment can be another type of fluid.

FIG. 2A is a perspective view of the wafer 30, and a portion of the exposure apparatus 10 of FIG. 1 including the optical assembly 16, the device stage 42, and the environmental system 26.

FIG. 2B is a cut-away view of the portion of the exposure apparatus 10 of FIG. 2A, including the optical assembly 16, the device stage 42, and the environmental system 26. FIG. 2B illustrates that the optical assembly 16 includes an optical housing 250A, a last optical element 250B, and an element retainer 250C that secures the last optical element 250B to the optical housing 250A. Additionally, FIG. 2B illustrates the gap 246 between the last optical element 250B and the wafer 30. In one embodiment, the gap 246 is between approximately 1 mm and 2 mm. In alternative embodiments, the gap 246 can be less than 1 mm or greater than 2 mm.

In one embodiment, the environmental system 26 fills the imaging field and the rest of the gap 246 with an immersion fluid 248 (illustrated as circles). The design of the environmental system 26 and the components of the environmental system 26 can be varied. In the embodiment illustrated in FIG. 2B, the environmental system 26 includes an immersion fluid system 252, a fluid barrier 254, a transport control system 255, and an electro-osmotic element 256. In this embodiment, (i) the immersion fluid system 252 delivers and/or injects the immersion fluid 248 into the gap 246, removes the immersion fluid 248 from the electro-osmotic element 256, and/or facilitates the movement of the immersion fluid 248 through the electro-osmotic element 256, (ii) the fluid barrier 254 inhibits the flow of the immersion fluid 248 away from near the gap 246, (iii) the transport control system 255 directs electrical voltage to the electro-osmotic element 256, and (iv) the electro-osmotic element 256 transfers and/or conveys the immersion fluid 248 flowing from the gap 246. The fluid barrier 254 also forms a chamber 257 near the gap 246 and retains the electro-osmotic element 256 near the gap 246.

The design of the immersion fluid system 252 can vary. For example, the immersion fluid system 252 can inject the immersion fluid 248 at one or more locations at or near the gap 246 and chamber 257, the edge of the optical assembly 16, and/or directly between the optical assembly 16 and the wafer 30. Further, the immersion fluid system 252 can assist in removing and/or scavenging the immersion fluid 248 at one or more locations at or near the device 30, the gap 246 and/or the edge of the optical assembly 16.

In the embodiment illustrated in FIG. 2B, the immersion fluid system 252 includes one or more injector pads 258 (only one is illustrated) positioned near the perimeter of the optical assembly 16 and an immersion fluid source 260. FIG. 2C illustrates one injector pad 258 in more detail. In this embodiment, each of the injector pads 258 includes a pad outlet 262 that is in fluid communication with the immersion fluid source 260. At the appropriate time, the immersion fluid source 260 provides immersion fluid 248 to the one or more pad outlets 262 that is released into the chamber 257.

The immersion fluid source 260 can include (i) a fluid reservoir (not shown) that retains the immersion fluid 248, (ii) a filter (not shown) in fluid communication with the fluid reservoir that filters the immersion fluid 248, (iii) a de-aerator (not shown) in fluid communication with the filter that removes any air, or gas from the immersion fluid 248, (iv) a temperature controller (not shown), e.g., a heat exchanger or chiller, in fluid communication with the de-aerator that controls the temperature of the immersion fluid 248, (v) a pressure source (not shown), e.g., a pump, in fluid communication with the temperature controller, and (vi) a flow controller (not shown) that has an inlet in fluid communication with the pressure source and an outlet in fluid communication with the pad outlets 262 (illustrated in FIG. 2C), the flow controller controlling the pressure and flow to the pad outlets 262. Additionally, the immersion fluid source 260 can include (i) a pressure sensor (not shown) that measures the pressure of the immersion fluid 248 that is delivered to the pad outlets 262, (ii) a flow sensor (not shown) that measures the rate of flow of the immersion fluid 248 to the pad outlets 262, and (iii) a temperature sensor (not shown) that measures the temperature of the immersion fluid 248 to the pad outlets 262. The operation of these components can be controlled by the control system 24 (illustrated in FIG. 1) to control the flow rate, temperature and/or pressure of the immersion fluid 248 to the pad outlets 262. The information from these sensors can be transferred to the control system 24 so that the control system 24 can appropriately adjust the other components of the immersion fluid source 260 to achieve the desired temperature, flow and/or pressure of the immersion fluid 248.

The orientation of the components of the immersion fluid source 260 can be varied. Further, one or more of the components may not be necessary and/or some of the components can be duplicated. For example, the immersion fluid source 260 can include multiple pumps, multiple reservoirs, temperature controllers or other components. Moreover, the environmental system 26 can include multiple immersion fluid sources 260.

The rate at which the immersion fluid 248 is pumped into the gap 246 (illustrated in FIG. 2B) can vary. For example, the immersion fluid 248 can be supplied to the gap 246 via the pad outlets 262 at a rate of approximately 0.5 liters/min to 1.5 liters/min.

The type of immersion fluid 248 can be varied to suit the design requirements of the apparatus 10. In one embodiment, the immersion fluid 248 is a fluid such as de-gassed, de-ionized water. Alternatively, for example, the immersion fluid 248 can be slightly contaminated de-ionized water or another type of suitable fluid.

FIGS. 2B and 2C also illustrate that the immersion fluid 248 in the chamber 257 sits on top of the wafer 30. As the wafer 30 moves under the optical assembly 16, it will drag the immersion fluid 248 in the vicinity of the top surface of the wafer 30 with the wafer 30 into the gap 246.

In one embodiment, the fluid barrier 254 forms the chamber 257 around the gap 246, restricts the flow of the immersion fluid 248 from the gap 246, assists in maintaining the gap 246 full of the immersion fluid 248, and facilitates the recovery of the immersion fluid 248 that escapes from the gap 246. In one embodiment, the fluid barrier 254 encircles and is positioned entirely around the gap 246 and the bottom of the optical assembly 16. Further, in one embodiment, the fluid barrier 254 confines the immersion fluid 248 to a region on the wafer 30 and the device stage 42 centered on the optical assembly 16. Alternatively, for example, the fluid barrier 254 can be positioned around only a portion of the gap 246, or the fluid barrier 254 can be off-center of the optical assembly 16.

In the embodiment illustrated in FIGS. 2B and 2C, the fluid barrier 254 includes a containment frame 264, and a frame support 266. In one embodiment, the containment frame 264 includes a frame section 268 and a transport housing section 270 that each encircle the gap 246 and the optical assembly 16. In this embodiment, the frame section 268 is generally annular ring shaped. The transport housing section 270 is secured to the bottom of the frame section 268. In one embodiment, the transport housing section 270 is made of plastic or another substantially non-conductive material.

FIG. 2D illustrates a perspective view of one embodiment of the transport housing section 270. In this embodiment, the transport housing section 270 is somewhat ring shaped. Further, referring back to FIGS. 2B and 2C, the transport housing section 270 includes an annular shaped housing channel 272 in the bottom of the transport housing section 270. The transport housing section 270 retains the electro-osmotic element 256 near the wafer 30. Additionally, the transport housing section 270 can include one or more fluid outlets 273A that are in fluid communication with the channel 272 and the electro-osmotic element 256. In this embodiment, the fluid outlets 273A also can be in fluid communication with a recovery reservoir 273B that receives the immersion fluid 248 from the fluid outlets 273A. Alternatively, for example, the fluid outlets 273A can be in fluid communication with the immersion fluid source 260 to recycle the recovered immersion fluid 248 that is exiting the gap 246.

The sections 268, 270 of the containment frame 264 can have another shape. For example, one or both of the sections 268, 270 of the containment frame 264 can be rectangular frame shaped, octagonal frame shaped, oval frame shaped, or another suitable shape.

The frame support 266 connects and supports the containment frame 264 to the apparatus frame 12, another structure, and/or the optical assembly 16, above the wafer 30 and the device stage 42. In one embodiment, the frame support 266 supports all of the weight of the containment frame 264. Alternatively, for example, the frame support 266 can support only a portion of the weight of the containment frame 264. In one embodiment, the frame support 266 can include one or more support assemblies 274. For example, the frame support 266 can include three spaced apart support assemblies 274 (only two are illustrated in FIG. 2B). In this embodiment, each support assembly 274 extends between the optical assembly 16 and the top of the frame section 268.

In one embodiment, each support assembly 274 is a mount that rigidly secures the containment frame 264 to the optical assembly 16. Alternatively, for example, each support assembly can be a flexure that supports the containment frame 264 in a flexible fashion. As used herein, the term “flexure” shall mean a part that has relatively high stiffness in some directions and relatively low stiffness in other directions. In one embodiment, the flexures cooperate (i) to be relatively stiff along the X axis and along the Y axis, and (ii) to be relatively flexible along the Z axis. In this embodiment, the flexures can allow for motion of the containment frame 264 along the Z axis and inhibit motion of the containment frame 264 along the X axis and the Y axis.

Alternatively, for example, each support assembly 274 can be an actuator that can be used to adjust the position of the containment frame 264 relative to the wafer 30 and the device stage 42. In this embodiment, the frame support 266 also can include a frame measurement system (not shown) that monitors the position of the containment frame 264. For example, the frame measurement system can monitor the position of the containment frame 264 along the Z axis, about the X axis, and/or about the Y axis. With this information, the support assemblies 274 can be used to adjust the position of the containment frame 264. In this embodiment, the support assemblies 274 can actively adjust the position of the containment frame 264.

FIGS. 2B and 2C also illustrate the electro-osmotic element 256 in more detail. In this embodiment, the electro-osmotic element 256 is a substrate 275 that is substantially annular disk shaped, encircles the gap 246 and the optical assembly 16, and is substantially concentric with the optical assembly 16. Alternatively, for example, the substrate 275 can be another shape, including oval frame shaped, rectangular frame shaped or octagonal frame shaped. Still alternatively, for example, the electro-osmotic element 256 can include a plurality of substrate segments that cooperate to encircle a portion of the gap 246, and/or a plurality of substantially concentric substrates.

The dimensions of the electro-osmotic element 256 can be selected to achieve the desired immersion fluid 248 recovery rate. For example, in alternative embodiments, the electro-osmotic element 256 can have (i) an inner diameter of approximately 6.5, 7, 8, 9, or 10 cm, (ii) an outer diameter of approximately 8.5, 9, 10, 11, or 12 cm, and (iii) a thickness of approximately 0.5, 1, 2, 3, or 4 mm.

Further, in this embodiment, the electro-osmotic element 256 is secured to the containment frame 264 and cooperates with the containment frame 264 to form a removal chamber 276 next to and above the electro-osmotic element 256.

Moreover, as illustrated in FIG. 2C, the electro-osmotic element 256 includes a first surface 278A that is adjacent to the removal chamber 276 and an opposite second surface 278B that is adjacent to the device 30 and the gap 246.

In this embodiment, the electro-osmotic element 256 captures, retains, and/or absorbs at least a portion of the immersion fluid 248 that flows between the containment frame 264 and the wafer 30 and/or the device stage 42.

The type of material utilized in the electro-osmotic element 256 can vary. FIG. 2E illustrates a side plan view of a portion of one embodiment of the electro-osmotic element 256. In this embodiment, the electro-osmotic element 256 is a substrate 275 such as a sponge, that includes a plurality of pores 280 that convey the immersion fluid 248 by capillary action. For example, the pores 280 can be relatively small and tightly packed. In one embodiment, the electro-osmotic element 256 can be a glass frit. Alternatively, other suitable materials can be utilized.

In one embodiment, the electro-osmotic element 256 has a pore size in the micron range. A suitable electro-osmotic element 256 can be purchased from Robu Glasfilter-Gerate GMBH, located in Hattert Germany.

Additionally, in one embodiment, the electro-osmotic element 256 includes a first conductive area 281A, a first electrical line 281B, a second conductive area 282A spaced apart from the first conductive area 281A and a second electrical line 282B. In one embodiment, the first conductive area 281A is positioned near the first surface 278A and the second conductive area 282A is positioned near the second surface 278B. In one embodiment, each conductive area 281A, 282A is a platinum coating that is deposited on the respective surface 278A, 278B. In this embodiment, each conductive area 281A, 282A does not clog the pores near the respective surface 278A, 278B. Alternatively, for example, one or more of the conductive areas 281A, 282A can be tantalum, gold or another thin film applied to the surface of the electro-osmotic element.

The first electrical line 281B electrically connects the first conductive area 281A to the transport control system 255 and the second electrical line 282B electrically connects the second conductive area 282A to the transport control system 255. A conductive epoxy (not shown) can be used to secure the electrical lines 281B, 282B to the respective conductive areas 281A, 282A.

The conductive areas 281A, 282A are in electrical communication with the transport control system 255. With this design, the transport control system 255 can apply a DC electrical voltage to the electro-osmotic element 256.

The transport control system 255 can include one or more processors and circuits. The transport control system 255 can be part of the control system 24 (illustrated in FIG. 1) or a separate control system.

Referring back to FIGS. 2B and 2C, the electrical voltage applied to the electro-osmotic element 256 causes the electro-osmotic element 256 to act as an electro-osmotic pump to capture the immersion fluid 248 that is exiting the gap 246. With this design, the immersion fluid 248 can be captured from the gap 246 and pumped into the removal chamber 276 and from the removal chamber 276 out the outlets 273A to the recovery reservoir 273B.

Stated another way, the transport control system 255 applies a voltage across the thickness of the electro-osmotic element 256. The voltage across the electro-osmotic element 256 causes the electro-osmotic element 256 to act as an electro-kinetic pump. In one embodiment, the transport control system 256 applies a DC voltage of the order of approximately 100 volts. In an alternative example, the transport control system 256 can apply a voltage across the electro-osmotic element 256 of approximately 5, 10, 20, 50, 150 or 200 volts DC.

In certain embodiments, a relatively higher flow capacity is required. To accommodate higher flow, larger porosity material has to be used for the electro-osmotic element 256 and larger voltages can be utilized. The choice for the porosity of the electro-osmotic element 256 depends on the overall flow rate requirement of the electro-osmotic element 256. Larger overall flow rates can be achieved by using a electro-osmotic element 256 having a larger porosity, decreasing the thickness of the electro-osmotic element 256, or increasing the surface area of the electro-osmotic element 256. The type and specifications of the porous material also depend on the application and the properties of the immersion fluid 248.

In one embodiment, the voltage across the electro-osmotic element 256 causes the immersion fluid 248 to move from the bottom second surface 278B of the electro-osmotic element 256 to the top first surface 278A of the electro-osmotic element 256. With this design, the electro-osmotic pump sucks the immersion fluid 248 off the surface of the wafer 30. With this design, the flow of the immersion fluid 248 through the electro-osmotic element 256 can be reversed by reversing the polarity of the voltage between the surfaces 278A, 278B. Stated another way, the direction of pumping of the immersion fluid 248 can be easily reversed so the same electro-osmotic element 256 can be used to apply immersion fluid 248 to the surface of the wafer 30 and to remove excess immersion fluid 248. Thus, in one embodiment, the invention provides a reversible system capable of both applying and capturing immersion fluid 248 from the surface.

FIG. 2C illustrates that a frame gap 284 exists between the second surface 278B of the electro-osmotic element 256, and the wafer 30 and/or the device stage 42 to allow for ease of movement of the device stage 42 and the wafer 30 relative to the containment frame 264. The size of the frame gap 284 can vary. In one embodiment, the frame gap 284 is between approximately 0.1 and 2 mm. In alternative examples, the frame gap 284 can be approximately 0.05, 0.1, 0.2, 0.5, 1, 1.5, 2, 3, or 5 mm.

With this embodiment, most of the immersion fluid 248 is confined within the fluid barrier 254 and most of the leakage around the periphery is scavenged within the narrow frame gap 284 by the electro-osmotic element 256. In this case, when the immersion fluid 248 touches the electro-osmotic element 256, it is drawn into the electro-osmotic element 256 and absorbed. Thus, the electro-osmotic element 256 inhibits any immersion fluid 248 from flowing outside the fluid barrier.

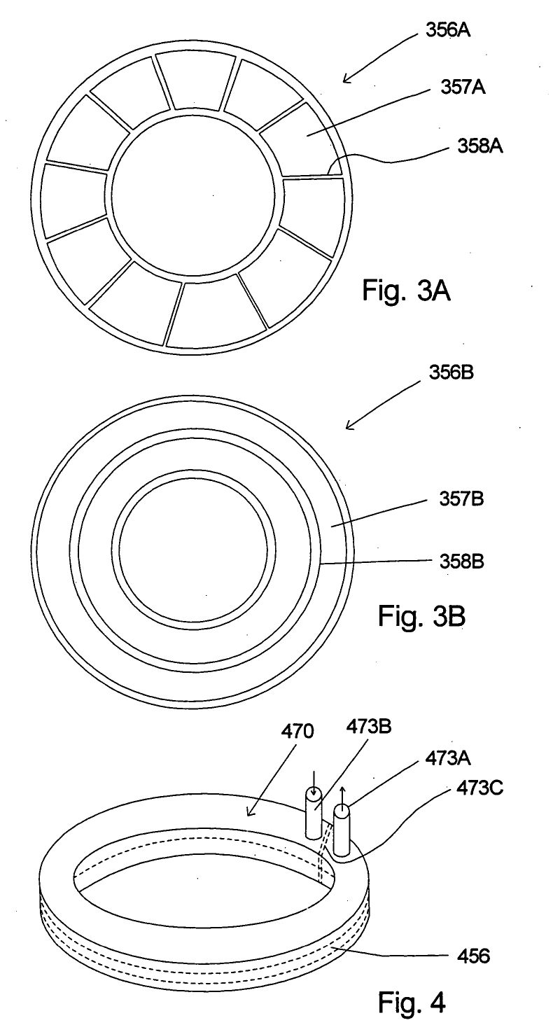

FIG. 3A illustrates a bottom view of another embodiment of the electro-osmotic element 356A. In this embodiment, the electro-osmotic element 356A is segmented azimuthally. More specifically, in this embodiment the electro-osmotic element 356A includes a plurality of element segments 357A that are separated by insulators 358A. For example, each element segment 357A is made of a porous material and each insulator 358B can be made of plastic or another substantially non-conductive material.

In this embodiment, the transport control system 255 (illustrated in FIG. 2B) can apply (i) the same voltage across each of the element segments 357A, (ii) a different voltage across each of the element segments 357A so that one or more of the element segments 357A captures more of the immersion fluid 248, and/or (iii) the transport control system 255 can apply an opposite voltage polarity to different element segments 357A so that some element segments 357A can draw immersion fluid 248 while other element segments 357A force immersion fluid 248 from the element segments 357A.

In one embodiment, for example, the element segments 357A on the front end of the electro-osmotic element 356A can be used to pump the immersion fluid 248 (illustrated in FIG. 2B) into the gap 246 (illustrated in FIG. 2B), and the element segments 357A on the back end of the electro-osmotic element 356A can be used to pump the immersion fluid 248 from the gap 246. With this design, when the device stage 42 (illustrated in FIG. 2B) reverses direction, the polarity of the voltage applied by the transport control system 255 to the element segments 357A could be switched.

FIG. 3B illustrates a bottom view of another embodiment of the electro-osmotic element 356B. In this embodiment, the electro-osmotic element 356B is divided into two annular disk shaped element segments 357B that are separated by insulators 358B. For example, each element segment 357B is made of a porous material and each insulator 358B can be made of plastic.

In one embodiment, for example, the element segment 357B near the center can be used to pump the immersion fluid 248 into the gap 246, and the element segment 357B on the outside can be used to pump the immersion fluid 248 from the gap 246.

FIG. 4 illustrates the electro-osmotic element 456 (illustrated in phantom), and another embodiment of a transport housing section 470. In this embodiment, the transport housing section 470 includes an outlet 473A, an inlet 473B, and a divider 473C that separates the outlet 473A from the inlet 473B. With this design, fresh immersion fluid 248 from the immersion fluid source 260 flows into the inlet 473B, around the transport housing section 470 and out of the outlet 473A. Stated another way, the fresh immersion fluid 248 flows continuously around the transport housing section 470 and is removed after traversing the entire transport housing section 470. With this design, fresh immersion fluid 248 is always available to be pumped through the electro-osmotic element 456 onto the surface of the wafer 30. Further, used immersion fluid 248 pumped into the transport housing section 470 through the electro-osmotic element 456 is swept out of the transport housing section 470 to be reprocessed. Voltage is supplied to the electro-osmotic element 456 as needed to either apply immersion fluid 248 to the surface of the wafer 30 or remove immersion fluid 248 from the surface of the wafer 30.

It should be noted that in each embodiment, additional electro-osmotic elements or transport segments can be added as necessary.

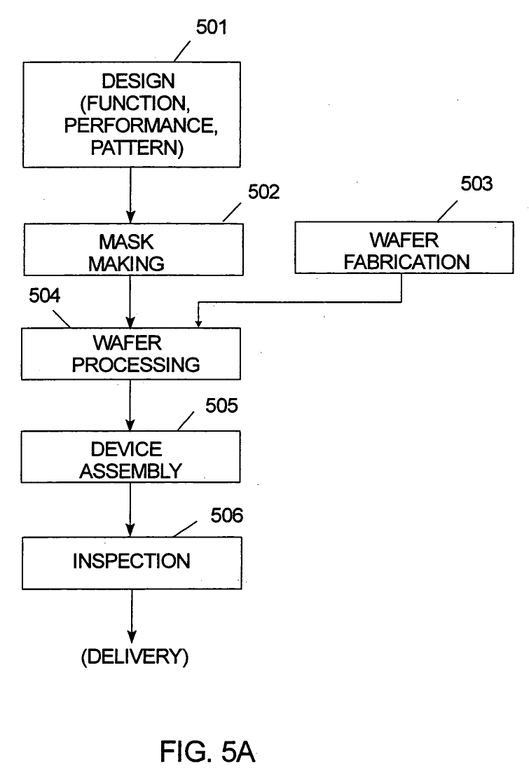

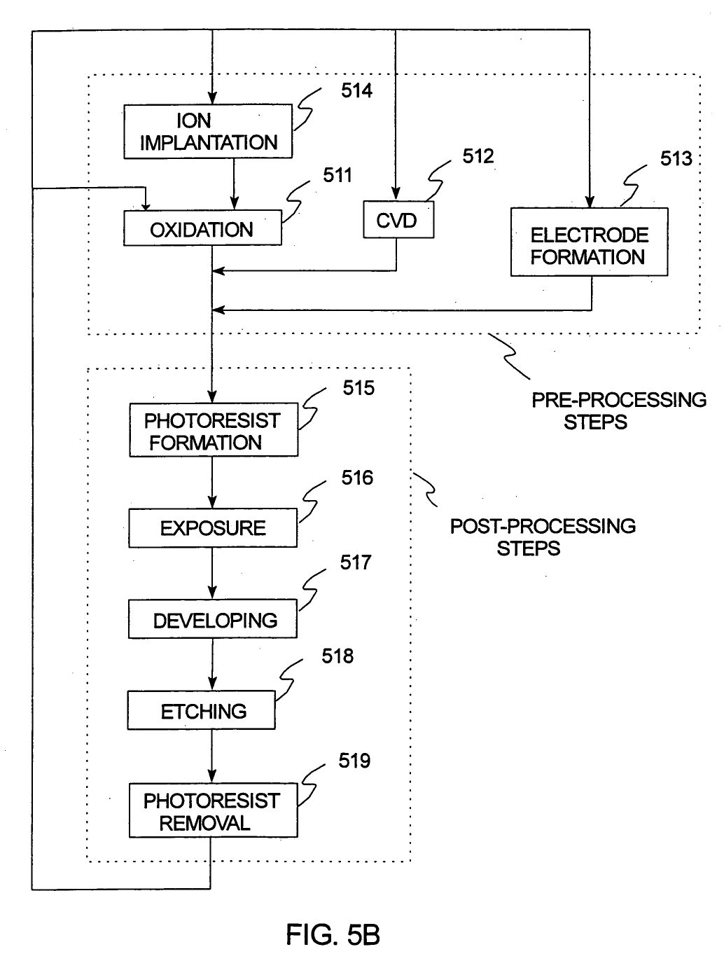

Semiconductor devices can be fabricated using the above described systems, by the process shown generally in FIG. 5A. In step 501 the device's function and performance characteristics are designed. Next, in step 502, a mask (reticle) having a pattern is designed according to the previous designing step, and in a parallel step 503 a wafer is made from a silicon material. The mask pattern designed in step 502 is exposed onto the wafer from step 503 in step 504 by a photolithography system described hereinabove in accordance with the invention. In step 505 the semiconductor device is assembled (including the dicing process, bonding process and packaging process), finally, the device is then inspected in step 506.

FIG. 5B illustrates a detailed flowchart example of the above-mentioned step 504 in the case of fabricating semiconductor devices. In FIG. 5B, in step 511 (oxidation step), the wafer surface is oxidized. In step 512 (CVD step), an insulation film is formed on the wafer surface. In step 513 (electrode formation step), electrodes are formed on the wafer by vapor deposition. In step 514 (ion implantation step), ions are implanted in the wafer. The above mentioned steps 511-514 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 515 (photoresist formation step), photoresist is applied to a wafer. Next, in step 516 (exposure step), the above-mentioned exposure device is used to transfer the circuit pattern of a mask (reticle) to a wafer. Then in step 517 (developing step), the exposed wafer is developed, and in step 518 (etching step), parts other than residual photoresist (exposed material surface) are removed by etching. In step 519 (photoresist removal step), unnecessary photoresist remaining after etching is removed.

Multiple circuit patterns are formed by repetition of these preprocessing and post-processing steps.

While the particular exposure apparatus 10 as shown and described herein is fully capable of obtaining the objects and providing the advantages described herein, it is merely illustrative of embodiments of the invention. No limitations are intended to the details of construction or design herein shown.

What is claimed is:

1. A lithography apparatus, comprising:
a stage that supports a work piece;
an optical assembly that projects an image onto the work piece on the stage;
a gap between the optical assembly and the work piece, the gap filled with an immersion fluid; and
an electrokinetic sponge positioned adjacent to the gap, the electrokinetic sponge transports immersion fluid that has exited the gap away from the gap.

2. The lithography apparatus of claim 1, wherein the electrokinetic sponge substantially surrounds the gap between the optical assembly and the work piece.

3. The lithography apparatus of claim 1, further comprising a control system that controls the transport of immersion fluid through the electrokinetic sponge.

4. The lithography apparatus of claim 1, wherein the electrokinetic sponge includes a plurality element segments that cooperate to substantially surround the gap between the optical assembly and the work piece.

5. An environmental system for maintaining a gap full of an immersion fluid, the gap being formed between an optical assembly and a device, the environmental system comprising:
an electro-osmotic element that is positioned near the device; and
a control system that applies a voltage across the electro-osmotic element that causes the immersion fluid to move through the electro-osmotic element.

6. The environmental system of claim 5, further comprising a fluid barrier that substantially encircles the gap, the fluid barrier maintaining the electro-osmotic element near the gap, and wherein the electro-osmotic element substantially encircles the gap.

7. The environmental system of claim 5, wherein the electro-osmotic element includes a plurality of pores.

8. The environmental system of claim 5, wherein the electro-osmotic element has a pore size in the micron range.

9. The environmental system of claim 5, further comprising an immersion fluid source that delivers the immersion fluid to the gap.

10. The environmental system of claim 5, wherein the control system applies a voltage of at least approximately five volts to the electro-osmotic element.

11. The environmental system of claim 5, wherein the electro-osmotic element includes a first surface and an opposite second surface that is positioned near the device and wherein the control system applies a voltage between the first and second surfaces of the electro-osmotic element.

12. The environmental system of claim 11, wherein the polarity of the voltage causes the immersion fluid to flow from the second surface to the first surface.

13. The environmental system of claim 11, wherein the polarity of the voltage causes the immersion fluid to flow from the first surface to the second surface.

14. The environmental system of claim 5, wherein the electro-osmotic element includes a first element segment, a second element segment and an insulator that separates the element segments.

15. The environmental system of claim 14, wherein the control system applies a first voltage to the first element segment and a second voltage to the second element segment, the first voltage being different than the second voltage.

16. The environmental system of claim 5, further comprising (i) a fluid barrier that cooperates with the electro-osmotic element to form a removal chamber adjacent to the electro-osmotic element, and (ii) an immersion fluid source that directs an immersion fluid into the removal chamber.

17. An exposure apparatus for transferring an image to a device, the exposure apparatus comprising: an optical assembly, a device stage that retains the device, and the environmental system of claim 5 that controls an environment in a gap between the optical assembly and the device.

18. An environmental system for maintaining a gap full of immersion fluid, the gap being formed between an optical assembly and a work piece, the environmental system comprising:
an electro-osmotic pump positioned near the work piece that captures immersion fluid that exits the gap.

19. The environmental system of claim 18, wherein the electro-osmotic pump includes an electro-osmotic element positioned near the work piece and a control system that applies a voltage across the electro-osmotic element that causes the immersion fluid to move through the electro-osmotic element.

20. The environmental system of claim 19, further comprising a fluid barrier that substantially encircles the gap, the fluid barrier maintaining the electro-osmotic element near the gap, and wherein the electro-osmotic element substantially encircles the gap.

21. The environmental system of claim 19, wherein the electro-osmotic element including a plurality of pores.

22. The environmental system of claim 19, further comprising an immersion fluid source that delivers the immersion fluid to the gap.

23. The environmental system of claim 19, wherein the electro-osmotic element includes a first surface and an opposite second surface that is positioned near the work piece and wherein the control system applies a voltage between the first and second surfaces of the electro-osmotic element.

24. The environmental system of claim 23, wherein the polarity of the voltage causes the immersion fluid to flow from the second surface to the first surface.

25. The environmental system of claim 23, wherein the polarity of the voltage causes the immersion fluid to flow from the first surface to the second surface.

26. The environmental system of claim 19, wherein the electro-osmotic element includes a first element segment, a second element segment and an insulator that separates the element segments.

27. The environmental system of claim 26, wherein the control system applies a first voltage to the first element segment and a second voltage to the second element segment, the first voltage being different than the second voltage.

28. A method for transferring an image to a work piece, the method comprising the steps of:
supporting the work piece with a stage;
providing an optical assembly that projects the image onto the work piece, the optical assembly being separated from the work piece by a gap;
filling the gap with an immersion fluid; and
transporting immersion fluid that has exited the gap with an electrokinetic sponge.

29. The method of claim 28, further comprising the step of encircling the gap with a fluid barrier, the fluid barrier maintaining the electrokinetic sponge near the gap, and wherein the electrokinetic sponge substantially encircles the gap.

30. The method of claim 28, further comprising the step of applying a voltage across the electrokinetic sponge with a control system that causes the immersion fluid to move through the electrokinetic sponge.

31. The method of claim 28, wherein the electrokinetic sponge includes a first surface and an opposite second surface that is positioned near the device and wherein the control system applies a voltage between the first and second surfaces of the electrokinetic sponge that causes immersion fluid to flow between the surfaces.

32. A method for making an exposure apparatus for transferring an image to a device, the method comprising the steps of providing an optical assembly, and controlling the environment in the gap by the method of claim 28.
